(19) United States
(12) Patent Application Publication
(10) Pub. No.: US 2016/0078796 A1
(43) Pub. Date: Mar. 17, 2016

(54) ELECTRONIC PAPER DISPLAY AND METHOD OF OPERATING THE SAME

(71) Applicant: Samsung Electro-Mechanics Co., Ltd., Suwon-si (KR)

(72) Inventors: Han Jin CHO, Seoul (KR); Jong Gi RYU, Yongin-si (KR); Dong Sik YOON, Hwaseong-si (KR)

(73) Assignee: Samsung Electro-Mechanics Co., Ltd., Suwon-si (KR)

(21) Appl. No.: 14/849,965

(22) Filed: Sep. 10, 2015

(30) Foreign Application Priority Data
Sep. 16, 2014 (KR) 10-2014-0122415
Oct. 30, 2014 (KR) 10-2014-0149650

(51) Int. Cl. G09G 3/20; G09G 3/34

(52) U.S. Cl. CPC G09G 3/2003; G09G 3/344

(57) ABSTRACT

A method of operating an electronic paper display, an electronic paper display, an apparatus for operating an electronic paper display, an apparatus for driving an electronic paper display, and an electronic shelf label including an electronic paper display are disclosed. The method of operating an electronic paper display involves, setting a display area to be a first color by operating, for a first duration, a transparent common electrode at a first level and segment electrodes, which comprise a data electrode and a background electrode, at a second level; and in response to the display area being set to be the first color, setting the display area to be a second color by operating, for a second duration different from the first duration, the transparent common electrode at the second level and the background electrode at the first level.

### CROSS-REFERENCE TO RELATED APPLICATION(S)

This application claims the benefit under 35 USC 119(a) of Korean Patent Application Nos. 10-2014-0122415, filed on Sep. 16, 2014, and 10-2014-0149650, filed on Oct. 30, 2014, in the Korean Intellectual Property Office, the entire disclosures of which are incorporated herein by reference for all purposes.

### BACKGROUND

1. Field

The following description relates to electronic paper displays, electronic shelf labels, and methods of operating the same.

2. Description of Related Art

As alternatives to paper labels, electronic shelf labels (ESLs) may be used on display stands to indicate product information and price in stores. ESLs usually operate on battery power; however, the use of electronic paper displays (EPDs) in electronic shelf labels can reduce power consumption because bistable EPDs maintain display information even after the power is turned off. However, when an ESL that uses an EPD is installed at a low temperature location, such as inside a refrigerator display case, its display function may be degraded or the displayed data may become faded and illegible.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of operating an electronic paper display, involving, setting a display area to be a first color by operating, for a first duration, a transparent common electrode at a first level and segment electrodes, which comprise a data electrode and a background electrode, at a second level; and in response to the display area being set to be the first color, setting the display area to be a second color by operating, for a second duration different from the first duration, the transparent common electrode at the second level and the background electrode at the first level.

The second duration may be longer than the first duration. The general aspect of the method may further involve, prior to the setting of the display area to be the first color, setting the display area to be the second color by operating the transparent common electrode at the second level and the segment electrodes at the first level.

A sequence of setting the display area to be the second color and the setting of the display area to be the first color may be repeated at least once prior to the setting of the portion of the display area to be the second color.

The setting of the display area to be the first color for the first duration and setting of portions of the display to be the second color for the second duration may be repeated at least once when display data is updated.

In another general aspect, an electronic paper display includes an electronic paper film; a transparent common electrode formed on one side of the electronic paper film; segment electrodes comprising a data electrode and a background electrode; and a driver configured to operate the transparent common electrode and the segment electrodes at two levels of voltage, wherein the driver comprises a data display processor configured to set a display area to be a first color by operating, for a first duration, the transparent common electrode at a first level and the segment electrodes at a second level, and then set the display area to be the second color by operating, for a second duration different from the first duration, the transparent common electrode at the second level and the background electrode at the first level.

The second duration may be longer than the first duration.

The driver may further include a film initializer configured to operate the segment electrodes to set the display area to be the second color before setting of the display area to be the first color.

In yet another general aspect, a method of operating an electronic paper display involves setting a display area to be a first color by operating, for a first duration, a transparent common electrode at a first level and segment electrodes, which comprise a data electrode and a background electrode, at a second level; and in response to the setting of the display area to be the first color, setting a portion of the display area to be a second color by operating, for a second duration, the transparent common electrode at the second level and the data electrode at the first level.

The second duration may be longer than the first duration.

The second duration may be longer than four seconds.

The general aspect of the method may further involve, prior to the setting of the display area to be the first color, setting the display area to be the second color by operating the transparent common electrode at the second level and the segment electrodes at the first level.

A sequence of setting the display area to be the second color and the setting of the display to be the first color may be repeated at least once prior to the setting of the portion of the display area to be the second color.

The setting of the display area to be the first color for the first duration and setting of a portion of the display area to be the second color for the second duration may be repeated at least once when display data is updated.

In another general aspect, an electronic paper display includes an electronic paper film, a transparent common electrode formed on one side of the electronic paper film, segment electrodes comprising a data electrode and a background electrode on another side of the electronic paper film, and a driver configured to operate electrodes at multiple levels of voltage, in which the driver includes a data display processor configured to set a display area to be a first color by operating, for a first duration, the transparent common electrode at a first level and the segment electrodes at a second level, the first level being greater than the second level, and then set the display area to be a second color by operating, for a second duration different from the first duration, the transparent common electrode at the second level and the data electrode at the first level.

The first color may be black, and the second color may be white.

The second duration may be longer than the first duration.

The second duration may be longer than four seconds.

The driver may further include a film initializer configured to operate the segment electrodes to display the first color and then the second color before the setting of the display area to be the first color.

In yet another general aspect, an apparatus for driving an electronic paper display includes a driver configured to apply a first voltage differential across a transparent electrode and segment electrodes of the electronic paper display during a first duration to set a display area to be a first color, and apply a second voltage differential across the transparent electrode and one of a data electrode and a background electrode of the segment electrodes during a second duration to display information by converting a portion of the display area to be a second color, in which the second duration is longer than the first duration.

The application of the first voltage differential across the transparent electrode and the segment electrodes may control the display area to become black, and the application of the second voltage differential may control a background of the display area to become white.

The driver includes a data display processor configured to set differing electrodes of the segment electrodes as either a background electrode or a data electrode based on the information to be displayed.

The driver may be configured to display the information in the display area by applying, for the second duration, the second voltage differential across the transparent electrode and the background electrode while maintaining a voltage applied to the data electrode for the first and second durations.

The driver may be configured to display the information in the display area by applying, for the second duration, the second voltage differential across the transparent electrode and the data electrode while maintaining a voltage applied to the background electrode for the first and second durations.

The driver may include a film initialization processor configured to apply the first voltage differential across the transparent electrode and the background and data electrodes, and then apply the second voltage differential across the transparent electrode and the background and data electrodes prior to the applying of the first voltage differential across the transparent electrode and segment electrodes during the first duration.

In another general aspect, an electronic paper display includes the general aspect of the apparatus for driving the electronic paper display described above, and an electronic paper display screen comprising the transparent electrode, an electronic paper film, and the segment electrodes, disposed in that order.

In another general aspect, an electronic shelf label includes the general aspect of the apparatus for driving the electronic paper display described above, an electronic paper display screen comprising the transparent electrode, an electronic paper film, and the segment electrodes, disposed in that order, and a housing surrounding the apparatus for driving the electronic paper display and the electronic paper display screen, so that the display area of the electronic paper display screen is exposed through an opening of the housing.

Other features and aspects will be apparent from the following detailed description, the drawings, and the claims.

### BRIEF DESCRIPTION OF THE DRAWINGS

FIG. 1 is a diagram illustrating an example of an electronic paper display.

FIG. 2 is a flowchart illustrating an example of a method of operating an electronic paper display.

FIG. 3 is a flowchart illustrating an example of a method of operating an electronic paper display.

FIG. 4 is a diagram comparing the display speed of an example of an electronic paper display depending on environmental temperature and the display speed of a comparative electronic paper display product (E Ink Carta™ by E Ink Holdings, Inc).

FIG. 5A is a diagram illustrating an example of a layout of segment electrodes in an electronic paper display.

FIG. 5B is a diagram illustrating an example of an electronic shelf label.

FIG. 6 is a diagram illustrating waveforms for signals used for driving electrodes of an electronic paper display according to an example of a method of operating the electronic paper display.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Electronic paper displays (EPDs) are broadly used as devices that display information. A black and white electronic paper display includes an electronic paper film filled with negatively charged black pigment particles and positively charged white pigment particles, wherein a transparent common electrode is formed on its front, and segment electrodes for the operation, on its back. Black and white EPDs produced by E Ink holdings, Inc. are bistable and reflective; thus, the display state is maintained during a state in which its operation voltage is no longer applied to the electrodes. In addition, the displayed information can be read without a backlight because the image is produced by reflection of light. Accordingly, black and white EPDs are suitable for low power applications.

Generally, EPDs reach a standard luminance that is within the range of approximately 0 to 50° C. and within the range of 100 to 300 ms. Brightness is expressed as a ‘luminance value (L*)’ and is divided into a scale of 0 to 100, 0 being the darkest and 100 being the brightest. If it is assumed that the luminance value L* is 25 at time t1 and 65 at time t2, the display speed may be expressed as the difference between t1 and t2 in terms of the time it takes when the value of L* changes from 25 to 65, or then vice versa, from 65 to 25.

Under normal temperature conditions, the EPDs generally do not have difficulties in displaying information. However, an electronic information label made with an EPD that is installed in a refrigerator display case for frozen foods or other low temperature conditions may exhibit very slow display speed, and may be in a state in which the displayed information is not readable.

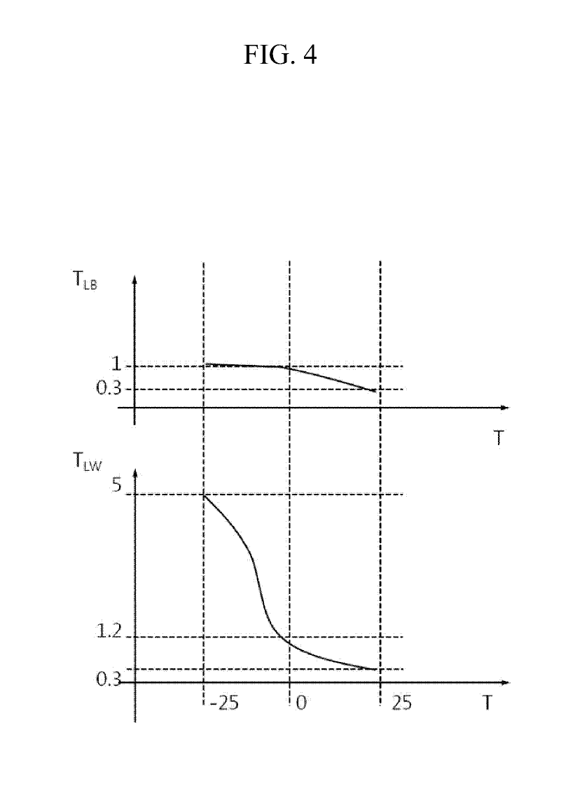

FIG. 4 includes a graph illustrating the display speed properties of a black and white EPD product, E Ink Carta™, produced by E Ink Holdings, Inc., according to various temperature conditions. The lower graph of FIG. 4 illustrates the display speed for changing between black to white, and the upper graph illustrates the display speed for changing between white to black. The y-axis corresponds to time it takes for making the change in seconds, and the x-axis corresponds to temperature in Celsius. According to the two graphs, there is no big difference between the display speed for changing between black to white versus changing between white to black at room temperature. However, the difference gets bigger as the temperature goes down to below 0° C. For example, at 25° C. below zero, it takes approximately five seconds to convert a black display screen to a white display screen, whereas it takes approximately one second to convert a white display screen to a black display screen. At 20° C. below zero, it takes more than four seconds to convert a black screen to a white screen, whereas it takes approximately one second to convert a white screen to a black screen[LC1]. At 10° C. below zero, it takes approximately three seconds or more to convert a black screen to a white screen, whereas it takes approximately one second to convert a white screen to a black screen.

An example of a technology described below may effectively remove the phenomenon of image persistence of display data on an electronic paper display in low-temperature environments so as to acquire a clear image and an improve display speed[LC2].

According to one example, a method of operating an EPD is disclosed. First, an entire display area of a display screen is set to be black, and then only the background electrode is set to display white, excluding the segments where data is to be displayed. To enhance the features in a low temperature environment, the entire display area may be set to be black, and then only the electrodes for the data area may be converted to display white. Compared to the operation of turning the entire portion of the display to black, the operation of turning a background or data electrode to white may be maintained longer. Prior to the operation of turning the entire portion of the display to black, an operation of turning the entire portion of the display to white may be added.

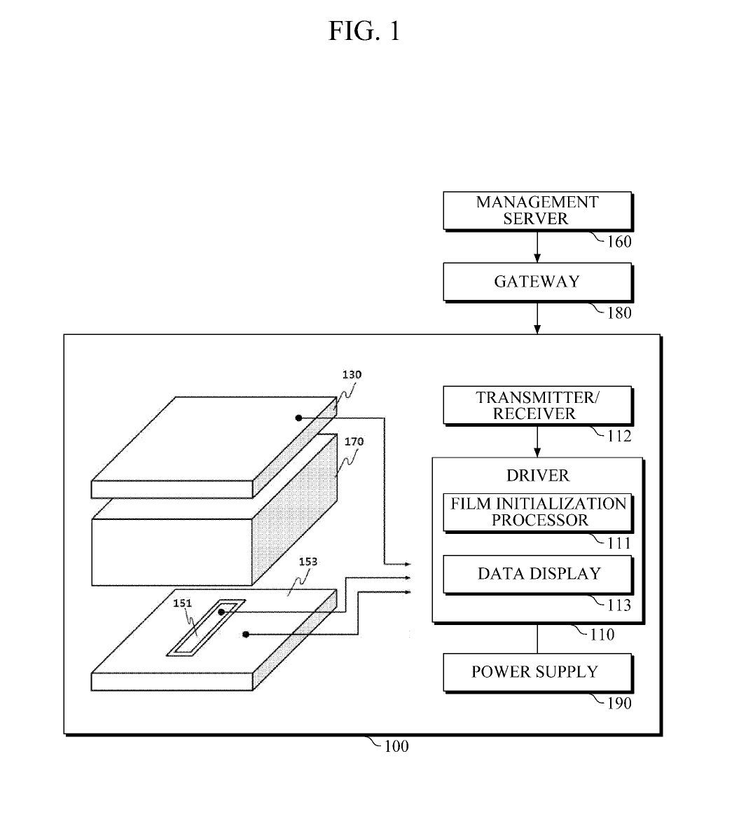

FIG. 1 is a diagram illustrating an example of an EPD that may be used to form an electronic information label or other display devices.

Referring to FIG. 1, an EPD 100 includes a transparent common electrode 130, an electronic paper film 170, segment electrodes, a driver 110, a transmitter/receiver 112 and a power supply 190. The EPD 100 receives display data from a management server 160 via a gateway 180. The management server 160 may be implemented with a computer or a terminal, having installed thereon an application that allows the user to enter information that is to be displayed on the EPD. The information may be received by the driver 110 via the gateway and the transmitter/receiver 112. According to one example, the EPD 100 is included in an ESL, and a plurality of ESLs communicate with a management server 160 to receive the information to be displayed on each ESL.

Within the electronic paper display screen, charged pigment particles are sealed inside the electronic paper film 170. In this example, the transparent common electrode 130 is formed on the front of the electronic paper film 170, and the front surface forms the display area of the display screen. On the back of the electronic paper film 170, segment electrodes are provided. The segment electrodes each comprises either a data electrode 151 or a background electrode 153. For example, if number ‘1’ is to be displayed by the electronic paper display, as illustrated in FIG. 1, the segment electrode includes a data electrode 151 in a manner that corresponds to the formation of an image for said T. The background electrode 153 corresponds to the background of said ‘1’. It could be that a single background electrode 153 is used in a display; however, depending on the operation load, multiple background electrodes 153 may be used.

A power supply 190 is an electric charge pump that generates operation voltage level B of 15V. A driver 110 may be a circuit that selectively provides the operation voltage to the transparent common electrode 130, the data electrode 151, and the background electrode 153 through switching. The driver 110 may, for example, be mounted on a circuit board including a microcontroller, multiple processors and memories.

According to one example of the electronic paper display, when an operation voltage, such as 15 V, is applied to an EPD's transparent common electrode while another voltage of 0 V is applied to said EPD's segment electrodes, negatively charged black pigment particles gather to the transparent common electrode so that the display surface area displays a black segment. On the contrary, when 0 V or a ground voltage is applied to the transparent common electrode and 15 V is applied to the segment electrodes, positively charged white pigment particles gather to the transparent common electrode so that the display surface area display a white segment. The level of such operation voltage may change according to the particles intended to be charged, and such variations are within the scope of this disclosure. In general, EPDs are operated in the following order: when 0 V is first applied to transparent common electrode and 15V is applied to all segment electrodes, which may each include a data electrode and a background electrode, the entire display area turns white. Next, when 15 V is then applied to the transparent common electrode, 0 V is applied to the data electrode of the segment electrodes, and 15 V is applied to the background electrode, the information is displayed in black.

It has been discovered by the inventor that the image of previously displayed information persists in the white background at low temperatures, resulting in wrong information being displayed in the display area or a user being unable to read the information, thus causing frustrations when an EPD is used in an electronic information label installed in a low-temperature environment. Further, through the above-mentioned analysis, the inventor has discovered that those difficulties are caused because electronic paper films are used without any consideration regarding the difference in display speeds between the conversion of black to white and that of white to black at low-temperature conditions. Generally, the operation timing of an electronic information label is designed so that it fits within the range of an ideal operation temperature around room temperature; however, since it takes a longer time to perform the conversion of black to white than that of white to black, before the entire display area of the display screen can turn white and eliminate any trace of residual image on the screen, the next operation may take place in the display device, resulting in display errors.

In addition, the EPD changes its colors when there is a change in the electric potential compared to the previous one, and maintains the previous color when the electric potential is the same. The EPD may operate two different levels. Of the background segment and the data segment, one always operates at and maintains the same voltage level as the transparent common electrode; as such, when content is displayed on the display screen, the displayed data's display state cannot be improved, but only be maintained. Since it takes time for all the display units to be operational, it is more reasonable, if not necessary, to select either the background or the display data. Such a selection process may prove to be crucial to a display's image definition in low-temperature environments, where delays occur during in displaying.

The existing method of changing the segment to show content in black from an entirely white state is one in which only the content part is changed to black while the white background is maintained. Thus, any residual image may cause areas that should be seen as a white background to be grey or black. That is, the luminance degree of black affects less visual image persistence, whereas the luminance degree of white causes visual image persistence. At room temperature, image persistence does not cause any problems even using such a waveform method because of E-paper's properties. However, at low temperatures, such as inside a refrigerator display stand, such an operation method may cause errors in displayed images.

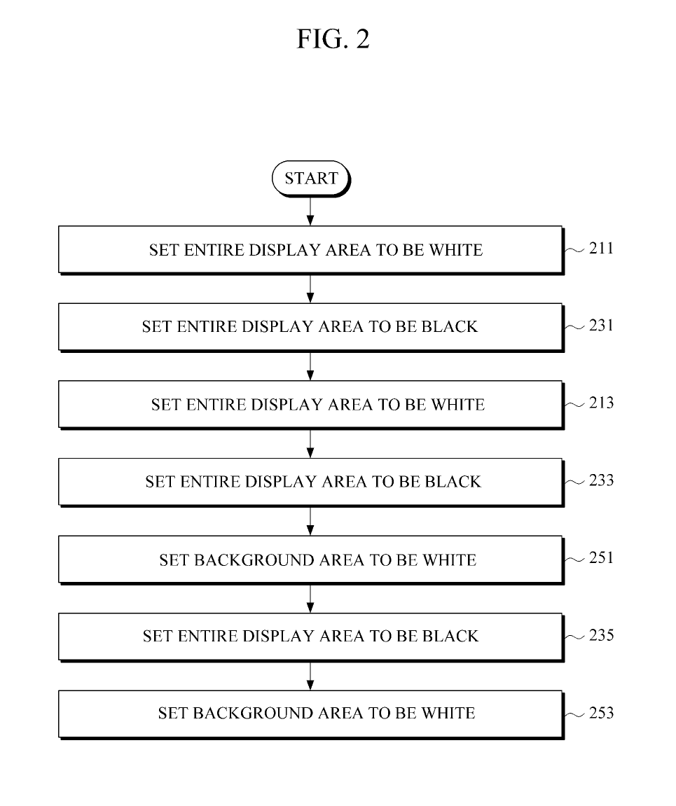

FIG. 2 is a flowchart illustrating an example of a method of operating an EPD. As mentioned earlier, the EPD operates in two levels. During the first duration, an EPD operates a transparent common electrode in a certain voltage level, which will be referred to as ‘level A’; and segment electrodes, which include a data electrode and a background electrode, in another voltage level that will be referred to as ‘level B’, in order to for its display area to be entirely black as in 233. While an example in which the display area uses white and black areas to indicate information is provided in this example, in another example, different color pairs, such as yellow and blue, or a lighter color (white) and a darker color (gray), may be used. Those skilled in the art recognizes that information may be displayed on a display screen using various combinations of shades or color. Then, in the second duration, the EPD operates the transparent common electrode at level B and the background electrode at level A so that the display area becomes white as in 251. In other words, the entire portion of the display area first becomes black, and then only the background portion becomes white. Since the conversion from white to black is much faster than that of black to white, this allows any previous information displayed on the screen to be effectively removed from the background and the display area to become a clear black in a short time. Then, the background electrode is operated at level A and the data electrode is operated at level B so that only the background area becomes white. Therefore, the data area is maintained to be black because the same voltage is applied to the front and back thereof, and the background area becomes white. The voltages previously given, 15V and 0V, could be, for example, level A and level B, respectively.

According to one embodiment, a second duration is set to be longer than a first duration. For example, the second duration may be set to be four times longer than the first duration. In another example, since it takes approximately five seconds for the conversion of black to white and approximately 1.2 seconds for the conversion of white to black under the condition of 25° C. below zero, the second duration may be set to be six seconds if the first duration may be set to be one point five seconds. Even though the second duration, which is the operating time period to turn the background area to white, is long, a user can quickly identify information to be displayed within one or two seconds in a state in which the black data area is still clear. The upper limit of the second duration may be determined according to the power that is consumed in the operation. Maintaining its operation longer than 30 seconds does not lead to efficient power use.

Prior to an operation 233 of turning the entire display area to black, an operating method of an EPD may further include an operation 213 of turning an entire display area to white by operating a transparent common electrode at level B and all of segment electrodes including both a data electrode and a background electrode at level A. Through the previously performed operation of turning the entire display area to white, the previous display data is partially removed, and the charged particles are accelerated to move so that the performance of turning the entire display area to black may be enhanced.

An operation of turning the entire display area to be white and an operation of turning the entire display area to be black may be repeatedly performed more than twice as illustrated in operations 211 to 233 in FIG. 2. Accordingly, the display data is partially removed, and the charged particles are accelerated to move so that performance of the operation may be enhanced.

When the display data is updated, displaying operations 233 and 251 may be repeatedly performed more than twice as illustrated in operations 233 to 253 in FIG. 2. If the displaying operations are repeatedly performed, the duration of the middle operation 251 of operating the data to be displayed may be short, and only the final operation 253 of operating the data to be displayed may have sufficient time for its performance.

In the first duration, a data display processor 113 of a driver 110 illustrated in FIG. 1 operates a transparent common electrode at level A, and all segment electrodes at level B so that the display area becomes black. Then, in the second duration, the data display processor 113 operates a transparent common electrode at level B and a background electrode at level A so that the display area becomes white. As described above, a film initialization processor 111 converts all the segment electrodes to display white prior to the operation of turning the entire display area to display black, i.e., prior to the operation of the data display processor 113.

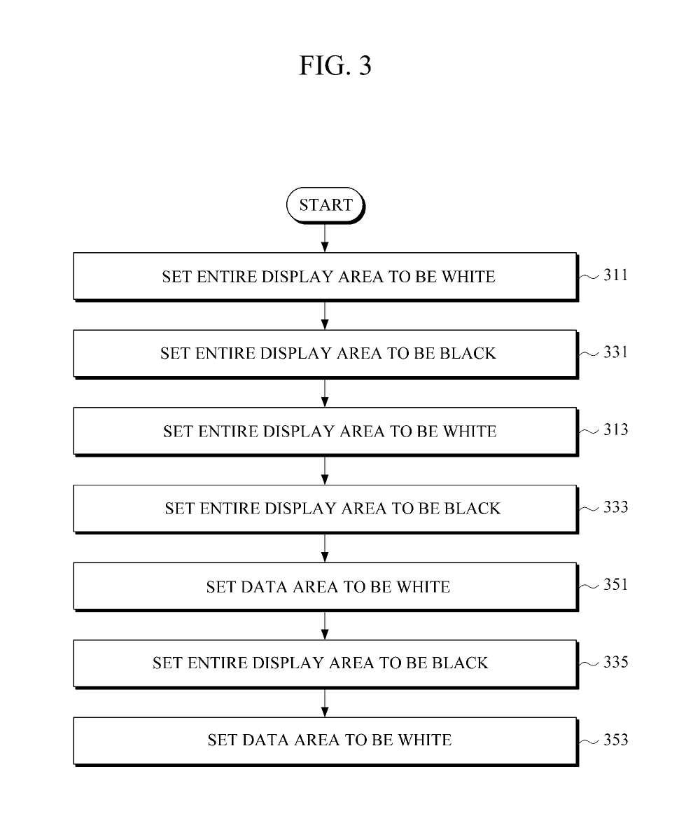

FIG. 3 is a flowchart illustrating an example of a method of operating an EPD. According to one embodiment, during the first duration, an EPD operates a transparent common electrode at level A, and segment electrodes, which include a data electrode and a background electrode, at level B, in order to turn the entire display area to black as in 333. Then, in the second duration, the EPD operates the transparent common electrode at level B and the data electrode at level A so that the display area becomes white as in 351. In other words, the entire portion of the display area first becomes black and then only the background becomes white. Thus, information is displayed in white in the black background. Since the conversion of white to black is much faster than the conversion of black to white, this allows any previous information displayed to be effectively removed from the background, and the display area to display a clear black in a short time. Then, the background electrode is operated at level B and the data electrode is operated at level A so that only the desired characters become white. Therefore, this means that the background area is maintained black because the same voltage is applied to the front and back thereof, and the data area turns white. The voltages previously given, 15 V and 0 V, could be, for example, for level A and level B, respectively. Even though the color of the data area turns slowly, a user can quickly identify information to be displayed in a state in which the black color on the background is clear.

In one embodiment, a second duration is set to be longer than a first duration. For example, the second duration may be set to be four times longer than the first duration. According to one embodiment, since it takes approximately five seconds for the conversion of black to white and approximately 1.2 seconds for the conversion of white to black under the condition of 25° C. below zero, the second duration may be set to six seconds while the first duration may be set to 1.5 seconds. Even though the second duration, which is the operating time period to turn the background area to white, is long, a user can quickly identify information to be displayed within one or two seconds in a state in which the black data area is still clear. The upper limit of the second duration may be determined according to the power that is consumed in the operation. Maintaining its operation for longer than 30 seconds does not lead to efficient power use. In another example, the first and second duration may be determined based on a difference in the time required for color conversion from white to black and black to white at a pre-determined low temperature.

Prior to an operation 333, of turning the entire display area to display black, a method of operating an EPD may further include an operation 313 of converting an entire display area to display white by operating a transparent common electrode at level B and all segment electrodes including both a data electrode and a background electrode at level A. Through the previously performed operation of converting the entire display area to be white, the previous display data is partially removed, and the charged particles are accelerated to move so that the performance of converting the entire display area to be black may be enhanced.

An operation of converting the entire display area to be white and an operation of converting the entire display area to be black may be repeatedly performed more than twice as illustrated in operations 311 to 333 in FIG. 2. Accordingly, the display data is partially removed, and the charged particles are accelerated to move so that performance of the operation may be enhanced.

In response to updating the display data, displaying operations 333 and 351 may be repeatedly performed more than twice as illustrated in operations 333 to 353 in FIG. 2. If the displaying operations are repeatedly performed, the duration of the middle operation 351 of operating the data to be displayed may be short, and only the final operation 353 of operating the data to be displayed may have sufficient time for its performance.

During the first duration, a data display processor 113 of a driver 110 illustrated in FIG. 1 operates a transparent common electrode at level A, and all segment electrodes at level B so that the display area becomes black. Then, during the second duration, the data display processor 113 operates a transparent common electrode at level A and a data electrode at level B so that the display area becomes white. As described above, a film initialization processor 111 converts all of the segment electrodes of an electronic paper display to be white prior to the operation of converting the entire display area to be black, for example, prior to the operation of the data display processor 113 to display data.

The examples described above may clearly display data by effectively removing the image persistence that appears on the contour of display data at low temperatures. In addition, by enhancing the degree of white for a white background, the display area of the display screen becomes clear. Furthermore, a display speed, which is the time it takes for the information to be displayed to the level of being recognized with human's naked eyes, may be improved.

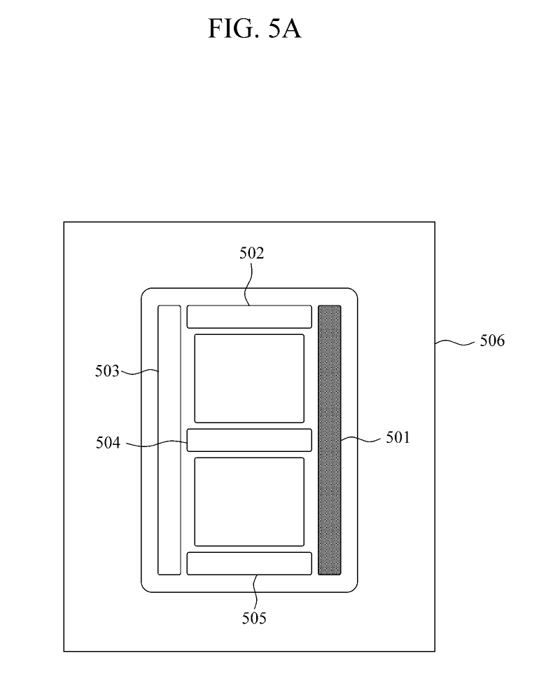

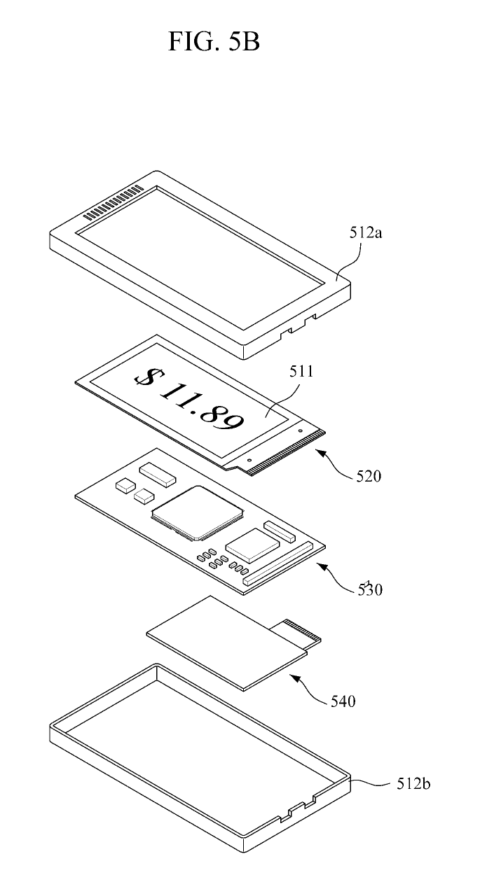

FIG. 5A illustrates an example of a layout of segment electrodes of an electronic paper display (EPD).

Referring to FIG. 5A, the EPD includes six different segment electrodes to which different voltage levels may be applied. To display information, one or more desired segment electrodes are set to one voltage while the remaining segment electrodes are set to another voltage. In the illustrate example, to display the character “1”, a segment electrode 501 may be designated as a data electrode and set to a first voltage level of 0 V while the transparent common electrode receives a second voltage of 15 V to display black pigments on surface of the EPD. The segments electrodes 502 to 506 may be designated as background electrodes and set to a second voltage of 15V[LC3] to display a white background area around the character “1”. Thus, to display the character “1”, the segment electrode 501 functions as a data electrode, while the segment electrodes 502 to 506 functions as background electrodes. However, to display character “E”, segment electrodes 502, 503, 504 and 505 may be designated as data electrodes, while segment electrodes 501 and 506 may be designated as background electrodes.

While this example is provided to further explain the operation of an electronic paper display, the present disclosure is not limited thereto. In another example, different arrangements of segment electrodes or color display may be used. In another example, the data may be displayed by turning the data area white while turning the background area black. In yet another example, the display area may include hundreds or thousands of pixels that divide the display area, much like the segments. In such an example, each pixel may be considered a segment.

Further, the driver 110 may include a display data processor that is configured to determine each electrode of the segment electrodes to be a data electrode or a background electrode based on display data received from an external source. In yet another example, the driver 110 may receive information regarding which segment electrodes are to be designated as data electrodes from an external source. Such variations are within the scope of the present disclosure.

FIG. 5B illustrates components of an example of an electronic shelf label (ESL) including an EP D[LC4].

Referring to FIG. 5B, the ESL includes an electronic paper display screen 520, a charging device 540, a circuit board 530 and a housing having an upper housing portion 512a and a lower housing portion 512b.

The display screen 520 has a display area 511 for showing display data, such as the price of an item, product name, sale status and the like. The display screen 520 includes a transparent common electrode, an electronic paper film and a plurality of segment electrodes. The ESL may receive the display data from a management server 160. According to one example, the management server 160 may be a terminal, such as a personal computer, a laptop or a PDA. The ESL may communicate with the management server 160 via a gateway 180 to receive the display data.

In this example, a transmitter/receiver is mounted on the circuit board 530, along with one or more processors and memories that serve as the driver. The charging device 540 includes an electronic charge pump that supplies power to the display screen 520, and connects to the driver via being connected to the circuit board. The connection between the display screen 520 and the circuit board 530 allows the driver to apply appropriate voltage levels to each electrodes within the display screen 520.

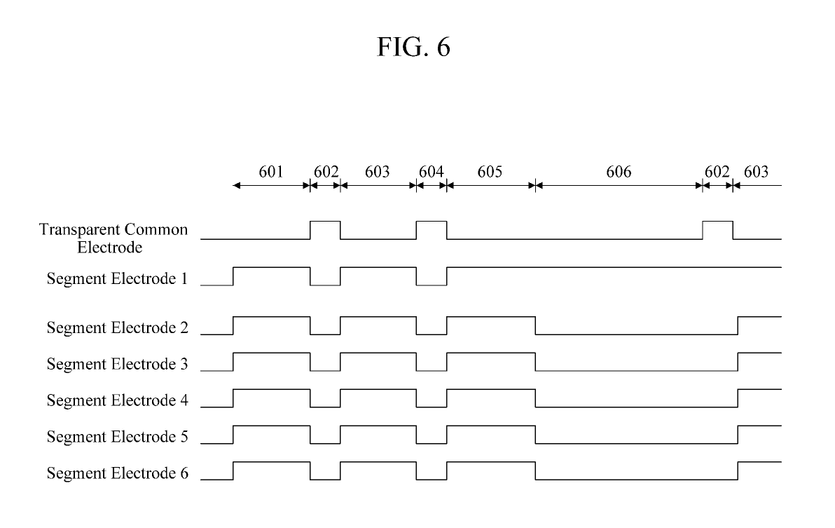

FIG. 6 illustrates waveforms of signals for driving each electrodes as applied by a driver according to an example of a method of operating an EPD. The description of the method of operating an EPD described with reference to FIG. 2 applies to this example. Accordingly, repetitive description thereof will be omitted [LC5].

Referring to FIG. 6, the EPD includes six different segments illustrated in FIG. 5A. During duration 601, to initialize the display screen, the film initialization processor 111 converts the entire display area to be white by applying a first voltage level of 15 V to all segment electrodes 501 to 506, which include both data segments and background segments, and a second voltage of 0 V to a transparent common electrode. During duration 602, the film initialization processor 111 converts the entire display area to be black by applying the first voltage level of 15 V to the transparent common electrode, and the second voltage level of 0 V to all segment electrodes 501 to 506. During duration 603, the film initialization processor 111 converts the entire display area to be white by applying the second voltage level of 0 V to the transparent common electrode and the first voltage level of 15 V to all segment electrodes 501 to 506.

Further the initialization period, to update the display area with the display data, during duration 604, the display data processor 113 converts the entire display area to be black by applying the first voltage level of 15 V to the transparent common electrode and the second voltage level of 0 V to the segment electrodes 501 to 506.

After turning the entire display area white, during duration 605, the data display processor 113 converts only the background area of the display area to be white while maintaining the data area to be black by applying the first voltage level of 15 V to a portion of segment electrodes 501 to 506 that correspond to the background area. In the example illustrated in FIG. 5A, segment electrodes 502 to 506 correspond to background electrodes to display the character “1,” and segment electrode 501 corresponds to a data electrode.

For a bistable electronic paper display, the display data shown on its display area is maintained even when the power is no longer applied to the electrodes of the display area. Thus, during duration 606, the desired information displayed on the display area during duration 605 is retained. The display area may be periodically refreshed by repeating durations 602 to 605, or 604 to 605.

While, in this example, the voltage levels of 0 V and 15 V are used for both the transparent electrode and the segment electrodes 501 to 506, different voltage levels may be used for transparent and segment electrodes in another example. For example, voltage levels of 0 V and 10 V may be used for the electrodes, or voltage levels of 0 V and 10 V may be applied to the transparent electrode while 0 V and 11 V may be applied to the segment electrodes. In other words, different voltage differentials may be applied across the transparent common electrode and the segment electrodes. Various variations would be apparent to those skilled in the art, and these variations are within the scope of the present disclosure.

Further, either or both of the length of duration 603 and the length of duration 605 may be longer than the length of duration 602 or duration 604. By setting the length of durations 603 and 605 to be longer than duration 604, the display area can be converted completely to display white without any image persistence. According to one example, the length of either or both of durations 603 and 605 may be equal to or greater than twice, three times or four times the length of duration 602 or duration 604. Further, the lengths of durations 601, 603 and 605 are the same is illustrated in FIG. 6; however, in another example, the length of durations 601, 603 and 605 may differ from one another.

The length of duration 606 may be determined based on how long the data is to be displayed on the EPD. For a bistable EPD, the image is retained even when no voltage is applied to the electrodes. For an extended display period, the display area may be periodically refreshed by repeating sequences 602 to 605.

Further, in the event that the data is to be displayed in white against a black background, in duration 605, the first voltage level of 15 V is applied to a data electrode, or segment electrode 501, and the second voltage level of 0 V is maintained in background electrodes, or segment electrodes 502 to 506. The transparent common electrode is maintained at the second voltage level of 0V during duration 605.

The apparatuses, units, modules, devices, drivers, power supply, film initialization processor, data display processor and other components illustrated in FIGS. 1, 5A and 5B that perform the operations described herein with respect to FIGS. 2, 3 and 6 are implemented by hardware components. Examples of hardware components include controllers, sensors, generators, drivers, circuits, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 2, 3 and 6. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2, 3 and 6 may be performed in part by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

As a non-exhaustive example only, a computer or a terminal as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of operating an electronic paper display, comprising:
setting a display area to be a first color by operating, for a first duration, a transparent common electrode at a first level and segment electrodes, which comprise a data electrode and a background electrode, at a second level; and
in response to the display area being set to be the first color, setting the display area to be a second color by operating, for a second duration different from the first duration, the transparent common electrode at the second level and the background electrode at the first level.

2. The method of claim 1, wherein the second duration is longer than the first duration.

3. The method of claim 1, further comprising, prior to the setting of the display area to be the first color, setting the display area to be the second color by operating the transparent common electrode at the second level and the segment electrodes at the first level.

4. The method of claim 3, wherein a sequence of setting the display area to be the second color and the setting of the display area to be the first color are repeated at least once prior to the setting of the portion of the display area to be the second color.

5. The method of claim 1, wherein the setting of the display area to be the first color for the first duration and setting of portions of the display to be the second color for the second duration are repeated at least once when display data is updated.

6. An electronic paper display, comprising:
an electronic paper film;
a transparent common electrode formed on one side of the electronic paper film;
segment electrodes comprising a data electrode and a background electrode; and
a driver configured to operate the transparent common electrode and the segment electrodes at two levels of voltage,
wherein the driver comprises a data display processor configured to set a display area to be a first color by operating, for a first duration, the transparent common electrode at a first level and the segment electrodes at a second level, and then set the display area to be the second color by operating, for a second duration different from the first duration, the transparent common electrode at the second level and the background electrode at the first level.

7. The electronic paper display of claim 6, wherein the second duration is longer than the first duration.

8. The electronic paper display of claim 6, wherein the driver further comprises a film initializer configured to operate the segment electrodes to set the display area to be the second color before setting of the display area to be the first color.

9. A method of operating an electronic paper display, comprising:
setting a display area to be a first color by operating, for a first duration, a transparent common electrode at a first level and segment electrodes, which comprise a data electrode and a background electrode, at a second level; and
in response to the setting of the display area to be the first color, setting a portion of the display area to be a second color by operating, for a second duration, the transparent common electrode at the second level and the data electrode at the first level.

10. The method of claim 9, wherein the second duration is longer than the first duration.

11. The method of claim 10, wherein the second duration is longer than four seconds.

12. The method of claim 9, further comprising, prior to the setting of the display area to be the first color, setting the display area to be the second color by operating the transparent common electrode at the second level and the segment electrodes at the first level.

13. The method of claim 12, wherein a sequence of setting the display area to be the second color and the setting of the display to be the first color are repeated at least once prior to the setting of the portion of the display area to be the second color.

14. The method of claim 9, wherein the setting of the display area to be the first color for the first duration and setting of a portion of the display area to be the second color for the second duration are repeated at least once when display data is updated.

15. An electronic paper display, comprising:
an electronic paper film;
a transparent common electrode formed on one side of the electronic paper film;
segment electrodes comprising a data electrode and a background electrode on another side of the electronic paper film; and
a driver configured to operate electrodes at multiple levels of voltage,
wherein the driver comprises a data display processor configured to set a display area to be a first color by operating, for a first duration, the transparent common electrode at a first level and the segment electrodes at a second level, the first level being greater than the second level, and then set the display area to be a second color by operating, for a second duration different from the first duration, the transparent common electrode at the second level and the data electrode at the first level.

16. The electronic paper display of claim 15, wherein the first color is black, and the second color is white.

17. The electronic paper display of claiml5, wherein the second duration is longer than the first duration.

18. The electronic paper display of claim 16, wherein the second duration is longer than four seconds.

19. The electronic paper display of claim 15, wherein the driver further comprises:
a film initializer configured to operate the segment electrodes to display the first color and then the second color before the setting of the display area to be the first color.

20. An apparatus for driving an electronic paper display, comprising:
a driver configured to apply a first voltage differential across a transparent electrode and segment electrodes of the electronic paper display during a first duration to set a display area to be a first color, and apply a second voltage differential across the transparent electrode and one of a data electrode and a background electrode of the segment electrodes during a second duration to display information by converting a portion of the display area to be a second color,
wherein the second duration is longer than the first duration.

21. The apparatus of claim 20, wherein the application of the first voltage differential across the transparent electrode and the segment electrodes controls the display area to become black, and the application of the second voltage differential controls a background of the display area to become white.

22. The apparatus of claim 20, wherein the driver comprises a data display processor configured to set differing electrodes of the segment electrodes as either a background electrode or a data electrode based on the information to be displayed.

23. The apparatus of claim 20, wherein the driver is configured to display the information in the display area by applying, for the second duration, the second voltage differential across the transparent electrode and the background electrode while maintaining a voltage applied to the data electrode for the first and second durations.

24. The apparatus of claim 20, wherein the driver is configured to display the information in the display area by applying, for the second duration, the second voltage differential across the transparent electrode and the data electrode while maintaining a voltage applied to the background electrode for the first and second durations.

25. The apparatus of claim 20, wherein the driver comprises a film initialization processor configured to apply the first voltage differential across the transparent electrode and the background and data electrodes, and then apply the second voltage differential across the transparent electrode and the background and data electrodes prior to the applying of the first voltage differential across the transparent electrode and segment electrodes during the first duration.

26. An electronic paper display comprising:
the apparatus for driving the electronic paper display according to claim 20; and
an electronic paper display screen comprising the transparent electrode, an electronic paper film, and the segment electrodes, disposed in that order.

27. An electronic shelf label comprising:
the apparatus for driving the electronic paper display according to claim 20;
an electronic paper display screen comprising the transparent electrode, an electronic paper film, and the segment electrodes, disposed in that order; and
a housing surrounding the apparatus for driving the electronic paper display and the electronic paper display screen, so that the display area of the electronic paper display screen is exposed through an opening of the housing.
